(19) United States
(12) Patent Application Publication
(10) Pub. No.: US 2005/0037053 A1
(43) Pub. Date: Feb. 17, 2005

(54) Animal feed

(76) Inventors: Mai Faurschou Isaksen, Hojbjerg (DK); Karsten M Kragh, Viby (DK); Troels Gravesen, Aarhus (DK)

Correspondence Address: STEPTOE & JOHNSON LLP, 1330 CONNECTICUT AVENUE, N.W., WASHINGTON, DC, 20036, US

(21) Appl. No.: 10/497,315

(22) PCT Filed: Dec. 13, 2002
(86) PCT No.: PCT/IB02/05771

(30) Foreign Application Priority Data
Dec. 13, 2001 (GB) 0129864.5

(51) Int. Cl. A23K 1/165; A23K 1/17

(52) U.S. Cl. 424/442; 426/53; 426/54

(57) ABSTRACT

The present invention relates to a component comprising an enzyme for use in a feed comprising strach: wherein the enzyme has amylase activity and is capable of degrading resistant starch.

### FIELD OF INVENTION

The present invention relates to a feed.

In particular, the present invention relates to a feed comprising starch suitable for animal consumption. For some embodiments the animal is poultry or swine.

### BACKGROUND TO THE INVENTION

The digestibility of starch in feeds is highly variable and dependent on a number of factors including the physical structure of both the starch and the feed matrix. Starch that is trapped within whole plant cells or within the food matrix and some starch granules that are not fully gelatinised, are hydrolysed only very slowly by (α-amylase and therefore may escape complete digestion in the small intestine. Starch and starch degradation products which are highly resistant to digestion by amylase in the small intestine become substrates for microbial fermentation in the large intestine. The calorific yield from starch fermented in the large intestine is less than that provided if starch is digested and absorbed in the small intestine, resulting in significant energy losses for the animal.

Starch degraded in the small intestine, before microbial degradation, is absorbed directly by the intestinal epitel, thereby efficiently releasing the energy of the feed to the animal. Of the starch degraded by the microbial community, only a fraction of the energy will be taken up by the animal. This implies that easily degradable starch and resistant starch digested by resistant starch degrading enzymes will be utilised more effectively than resistant starch, which is degraded by the microbial flora.

De Schrijver et al (6) report that rats and pigs fed resistant starch have a significantly lower apparent ileal energy digestibility compared to those fed easily degradable starch, even when the amount of resistant starch is only present in an amount of about 6% of the total diet.

Dietary fibres and resistant starch are substrates for the microflora in the colon of monogastric animals. Extensive investigations have been carried out in order to estimate the amount of resistant starch escaping the small intestine of humans, due to the importance of these substrates for human health. The most accepted effect of resistant starch is formation of volatile fatty acids, VFA, which prevent colon cancer, but resistant starch may also have other beneficial effects (16). Most reported trials have been made in humans (mostly with human ileostomates, reviewed in for example (11)), although trials with pigs and rats have also been made.

Investigations comparing in vivo (human) and in vitro degradation of different types of starch which demonstrate that the in vitro model degradation gives reliable results. For example, Silvester et al. (24) have quantified the amount of resistant starch escaping the small intestine in ileostomates and compared it with an in vitro digestion based on the method described by Englyst et al. (8). They have found that 97% of all resistant starch escapes the small intestine.

Similarly, investigations by Englyst et al. have shown greater than 91% resistant starch escapes digestion in the small intestine.

Resistant starch may be defined to consist of several different types of starch, one being raw starch. This has been experimentally shown by, for example, Muir et al (20), who identified raw starch as an example of resistant starch.

De Schrijver et al. (6) report faecal digestible and metabolisable energy values which were significantly lower in rats receiving resistant starch. In addition, resistant starch intake by pigs lowered the apparent ileal energy digestibility significantly when retrograded high-amylose corn starch was fed.

Ranhotra et al. (22) found that rats given resistant starch gained significantly less weight than a group given easily degradable starch.

Ito et al. (15) have quantified the amount of starch in different parts of the digestive system in rats fed three different diets with normal starch, unprocessed high resistant starch maize, and processed high resistant starch maize. They have found that rats given diets with resistant starch, in particular processed resistant starch, have a higher content of starch in the caecum. Furthermore, by comparing digestion of resistant starch in humans and rats, Roe et al. (23) have found that rats are more efficient in utilising resistant starch and non-starch polysaccharides than humans.

In contrast, Moran (19) reports that starch digestion is not a problem in fowl, implying that all starch is capable of being degraded and assimilated in the digestive system of fowl such as chickens.

The present invention seeks to provide a useful means to prepare a feed for animal consumption that may contain starch.

### Present Invention

In a broad aspect, the present invention relates to the use of a component comprising an enzyme for use in a feed comprising starch. The present invention also relates to feeds that have been admixed with said component.

In one aspect, the present invention relates to the use of a component comprising an enzyme which has amylase activity and is capable of degrading resistant starch for use in a feed comprising starch. The present invention also relates to feeds that have been admixed with said component.

### Statements of Invention

Aspects of the invention are presented in the accompanying claims and in the following description.

By way of example, in a first aspect the present invention relates to a component for use in a feed comprising starch wherein said component comprises an enzyme; wherein the enzyme has amylase activity and is capable of degrading resistant starch.

In a second aspect, the present invention relates to a feed comprising a starch and an enzyme, wherein the enzyme has amylase activity and is capable of degrading resistant starch.

In a third aspect the present invention relates to a method of degrading resistant starch in a feed comprising contacting said resistant starch with an enzyme having amylase activity and which is capable of degrading said resistant starch.

In a fourth aspect the present invention relates to the use of an enzyme in the preparation of a feed comprising a starch, to degrade resistant starch, wherein the enzyme has amylase activity and is capable of degrading said resistant starch.

In a fifth aspect the present invention relates to the use of an enzyme in the preparation of a feed to improve the calorific value of said feed, wherein the enzyme has amylase activity and is capable of degrading resistant starch.

In a sixth aspect the present invention relates to the use of an enzyme in the preparation of a feed to improve animal performance, wherein the enzyme has amylase activity and is capable of degrading resistant starch.

In a further aspect, the present invention relates to a process for preparing a feed comprising admixing a starch and an enzyme, wherein the enzyme has amylase activity and is capable of degrading resistant starch.

In yet a further aspect, the present invention relates to a process for identifying a component for use in a feed, wherein said component comprises an enzyme, said process comprising contacting resistant starch with a candidate component and determining the extent of degradation of said resistant starch; wherein said enzyme has amylase activity and is capable of degrading said resistant starch.

### Some Preferred Aspects

In a preferred aspect, the enzyme for use in the present invention is an amylase enzyme.

In a preferred aspect, the enzyme for use in the present invention is thermostable.

In a preferred aspect, the enzyme for use in the present invention is pH stable

In a preferred aspect the enzyme for use in the present invention is a raw starch degrading enzyme.

In a preferred aspect the enzyme for use in the present invention is an amylase enzyme selected from the group consisting of Bacillus circulans F2 amylase, Streptococcus bovis amylase, Cryptococcus S-2 amylase, Aspergillus K-27 amylase, Bacillus licheniformis amylase and Thermomyces lanuginosus amylase.

In a preferred aspect of the present invention the feed is for swine or for poultry.

In a more preferred aspect of the present invention the feed contains a raw material such as a legume or a cereal.

### Some Advantages

Some advantages of the present invention are presented in the following commentary.

By way of example, use of a component comprising an enzyme having amylase activity and which is capable of degrading resistant starch is advantageous because there is a marked increase in the degradation of starch and/or starch degradation products in an animal.

In addition, use of a component comprising an enzyme having amylase activity and which is capable of degrading resistant starch is advantageous because there is a marked increase in the digestibility of starch and/or starch degradation products by an animal.

By way of further example, use of a component comprising an enzyme which has amylase activity and which is capable of degrading resistant is advantageous because it provides a means of enhancing the efficiency of deriving energy from a feed by an animal.

In addition, use of a component comprising an enzyme which has amylase activity and which is capable of degrading resistant starch is advantageous because it provides a means to enhance the bioavailability of resistant starch.

### Feed

Animal feeds for use in the present invention may be formulated to meet the specific needs of particular animal groups and to provide the necessary carbohydrate, fat, protein and other nutrients in a form that can be metabolised by the animal.

Preferably, the animal feed is a feed for swine or poultry.

As used herein the term ‘swine’ relates to non-ruminant omnivores such as pigs, hogs or boars. Typically, swine feed includes about 50 percent carbohydrate, about 20 percent protein and about 5% fat. An example of a high energy swine feed is based on corn which is often combined with feed supplements for example, protein, minerals, vitamins and amino acids such as lysine and tryptophan. Examples of swine feeds include animal protein products, marine products, milk products, grain products and plant protein products, all of which may further comprise natural flavourings, artificial flavourings, micro and macro minerals, animal fats, vegetable fats, vitamins, preservatives or medications such as antibiotics.

It is to be understood that where reference is made in the present specification, including the accompanying claims, to ‘swine feed’ such reference is meant to include “transitions” or “starter” feeds (used to wean young swine) and “finishing” or “grower” feeds (used following the transition stage for growth of swine to an age and/or size suitable for market).

As used herein the term ‘poultry’ relates to fowl such as chickens, broilers, hens, roosters, capons, turkeys, ducks, game fowl, pullets or chicks. Poultry feeds may be referred to as “complete” feeds because they contain all the protein, energy, vitamins, minerals, and other nutrients necessary for proper growth, egg production, and health of the birds. However, poultry feeds may further comprise vitamins, minerals or medications such as coccidiostats (for example Monensin sodium, Lasalocid,

Amprolium, Salinomycin, and Sulfaquinoxaline) and/or antibiotics (for example Penicillin, Bacitracin, Chlortetracycline, and Oxytetracycline).

Young chickens or broilers, turkeys and ducks kept for meat production are fed differently from pullets saved for egg production. Broilers, ducks and turkeys have larger bodies and gain weight more rapidly than do the egg-producing types of chickens. Therefore, these birds are fed diets with higher protein and energy levels.

It is to be understood that where reference is made in the present specification, including the accompanying claims, to ‘poultry feed’ such reference is meant to include “starter” feeds (post-hatching), “finisher”“grower” or “developer” feeds (from 6-8 weeks of age until slaughter size reached) and “layer” feeds (fed during egg production).

Animal feeds for use in the present invention are formulated to meet the animal's nutritional needs with respect to, for example, meat production, milk production, egg production, reproduction and response to stress. In addition, the animal feeds for use in the present invention are formulated to improve manure quality.

In a preferred aspect the animal feed contains a raw material such as a legume, for example pea or soy or a cereal, for example wheat, corn (maize), rye or barley. Suitably, the raw material may be potato.

### Starch

Starch is the predominant food reserve substance in plants and provides 70-80% of the calories consumed by humans world-wide. Starch, products derived from starch, and sucrose constitute most of the digestible carbohydrate in the animal diet. The amount of starch used in the preparation of food products greatly exceeds the amount of all other feed components combined.

Starch occurs naturally as discrete particles called granules, which are relatively dense and insoluble. Most starch granules are composed of a mixture of two polymers: an essentially linear polysaccharide called amylose and a highly branched polysaccharide called amylopectin.

Amylopectin is a very large, branched molecule consisting of chains of α-D-glucopyranosyl units joined by (1→4) linkages, wherein said chains are attached by α-D-(1→6) linkages to form branches.

Amylopectin is present in all natural starches, constituting about 75% of most common starches. Starches consisting entirely of amylopectin are known as waxy starches, e.g. waxy corn (waxy maize).

Amylose is essentially a linear chain of (1→4) linked α-D-glucopyranosyl units having few α-D-(16) branches. Most starches contain about 25% amylose.

Undamaged starch granules are not soluble in cold water but can imbibe water reversibly. On heating, in the presence of water, however, molecular order within the starch granules is disrupted. This process is known as gelatinisation. Continued heating of starch granules in excess water results in further swelling and additional leaching of soluble components. On application of a shear the granules are disrupted and a paste is formed. On cooling, some starch molecules begin to re-associate, forming a precipitate or gel. This process is known as retrogradation or setback.

Starch molecules, like other polysaccharide molecules, are de-polymerised by hydrolysis to form monosaccharides and oligosaccharides such as glucose and maltose. Enzymes such as amylase and amyloglucosidase (glucoamylase) hydrolyse starch to D-glucose. Debranching enzymes, such as isoamylase or pullanase hydrolyse (1→6) linkages in amylopectin. Cyclodextrin glucanotransferases form rings of (1→4) linked a-D-glucopyranosyl units from amylose and amylopectin.

The functional properties of native starches such as gelatinisation, retrogradation and paste formation may be improved by modification. Modification increases the ability of starch pastes to withstand heat and acid associated with processing conditions and introduces specific functionalities. Modified starches are functional and abundant food macroingredients and additives.

Typically, modifications may be made singly or in combination such as crosslinking or polymer chains, non-crosslinking derivatisation and pregelatinisation. Specific improvements that can be obtained include increased solubility, inhibition of gel formation, improvement of interaction with other substances and improvement in stabilising properties.

It is to be understood that where reference is made in the present specification, including the accompanying claims, to ‘starch’ such reference is meant to include native starch and starch which has been partially or wholly modified, for example stabilised, crosslinked, pregelatinised or derivatised.

### Resistant Starch

Resistant starch has been defined as “the sum of starch and products of starch degradation not absorbed in the small intestine of healthy individuals” (3).

Resistant starch is a heterogeneous mixture with at least four main types:

Resistant starch 1—physically trapped starch, found in coarsely ground or chewed cereals, legumes and grains;

Resistant starch 2—resistant starch granules or ungelatinised starch granules which are highly resistant to digestion by a-amylase until gelatinised, e.g. raw starch such as uncooked potato, green banana and high-amylose starch;

Resistant starch 3—retrograded starch polymers (mainly amylose) which are produced when starch is cooled after gelatinisation. Retrograded amylose is highly resistant to enzymic attack, while retrograded amylopectin is less resistant and can be gelatinised by reheating; and

Resistant starch 4—chemically modified starch.

The amounts of all four types of resistant starch in foods can be manipulated through food processing techniques and plant breeding practices (e.g. high or low amylose variants of cereals and grains).

The amounts of starch reaching the large intestine (colon) is greatly influenced by the nature of an animal's diet (i.e. the quantity and botanical sources of starch) and the influence of processing in the preparation of feeds comprising starch. By way of example the amount of resistant starch in uncooked feed materials has been classified by Goni et al. (10) as follows:

| Resistant starch material (% dry matter) | |
|---|---|
| Negligible (<1%) | Boiled potato (hot) |
| | Boiled rice (hot) |
| | Pasta |
| | Breakfast cereal |
| | (containing bran) |
| | Wheat flour |
| Low (1-2.5%) | Breakfast cereal |
| | Biscuits |
| | Bread |
| | Pasta |
| | Boiled potato (cool) |
| | Boiled rice (cool) |
| Intermediate (2.5-5%) | Breakfast cereals |
| | fried potatoes |
| | Extruded vegetables |
| High (5-10%) | Cooked legumes |
| | (lentils, chick peas, beans) |
| | Peas |
| | Raw rice |
| | Autoclaved and cooled starches |
| | (wheat, potato, maize) |
| | Cooked and frozen |
| | starchy foods |
| Very high (>10%) | Raw potatoes |
| | Raw legumes |
| | Amylomaize |
| | Unripe banana |
| | Retrograded amylose |

Feeds for use in the present invention may comprise starch, which may be any one or more of the four types of resistant starch 1-4 as described above. In addition, the feeds for use in the present invention may comprise easily degradable starch and/or resistant starch such as encapsulated starch or raw starch.

To date, no one has suggested the use of a component comprising an enzyme which has amylase activity and which is capable of degrading resistant starch for use in a feed comprising starch. By way of example, reference can be made to the following teaching.

Muir et al (Am.J.Nutr. 1995, vol.61, pages 82-89) teach the effects of food processing and different maize varieties which affect the amounts of starch escaping digestion in the small intestine. In particular, they teach that starch-containing foods can be manipulated to increase the amount of starch that escapes digestion, for example by using high-amylose rather than normal varieties of cereals or by coarser milling of grains.

### Amylase

Suitable enzymes for use in the present invention may be capable of hydrolysing or degrading starch such as resistant starch and/or starch degradation products.

In one aspect, the enzymes for use in the present invention are amylases, i.e. enzymes capable of hydrolysing starch to monosaccharides and/or oligosaccharides, and/or derivatives (eg. dextrins) thereof.

As used herein the term “amylase” relates to an endoenzyme such as α-amylase which participates in the pathway responsible for the breakdown of starch to reducing sugars such as monosaccharides or oligosaccharides for example disaccharides such as maltose. In particular, α-amylase catalyses the endohydrolysis of 1,4-α-glucosidic linkages with the production of mainly a-maltose from amylose (a homopolymer of glucose linked by a(1→4) bonds) or amylopectin.

Alpha-amylases are of considerable commercial value, being used in the initial stages (liquefaction) of starch processing; in alcohol production; as cleaning agents in detergent matrices; and in the textile industry for starch desizing.

Alpha-amylases are produced by a wide variety of microorganisms including Bacillus, Aspergillus and Thenmomyces. Most commercial amylases are produced from B. licheniformis, B. amyloliquefaciens, B. subtilis, or B. stearothermophilus. In recent years the preferred enzymes in commercial use have been those from B. licheniformis because of their heat stability and performance, at least at neutral and mildly alkaline pH's.

Preferably, the amylases are selected from Bacillus circulans F2 amylase, Streptococcus bovis amylase, Cryptococcus S-2 amylase, Aspergillus K-27 amylase, Bacillus licheniformis amylase and/or Themnomyces lanuginosus amylase.

Recombinant DNA techniques have been used to explore which residues are important for the catalytic activity of amylases and/or to explore the effect of modifying certain amino acids within the active site of various amylases (Vihinen, M. et al. (1990) J. Bichem. 107:267-272; Holm, L. et al. (1990) Protein Engineering 3:181-191; Takase, K. et al. (1992) Biochemica et Biophysica Acta, 1120:281-288; Matsui, I. et al. (1992) Febs Letters Vol. 310, No. 3, pp. 216-218); which residues are important for thermal stability (Suzuki, Y. et al. (1989) J. Biol. Chem. 264:18933-18938); and one group has used such methods to introduce mutations at various histidine residues in a B. lichenifomis amylase (known to be thermostable). When compared to other similar Bacillus amylases, a B. lichenifomis amylase has an excess of histidines and, therefore, it was suggested that replacing a histidine could affect the thermostability of the enzyme (Declerck, N. et al. (1990) J. Biol. Chem. 265:15481-15488; FR 2 665 178-A1; Joyet, P. et al. (1992) Bio/Technology 10:1579-1583).

Commercially, alpha-amylase enzymes can be used under dramatically different conditions such as both high and low pH conditions, depending on the commercial application. For example, alpha-amylases may be used in the liquefaction of starch, a process preferably performed at a low pH (pH <5.5). On the other hand, amylases may be used in commercial dish care or laundry detergents, which often contain oxidants such as bleach or peracids, and which are used in much more alkaline conditions.

In order to alter the stability or activity profile of amylase enzymes under varying conditions, it has been found that selective replacement, substitution or deletion of oxidizable amino acids, such as a methionine, tryptophan, tyrosine, histidine or cysteine, results in an altered profile of the variant enzyme as compared to its precursor. Because currently commercially available amylases are not acceptable (stable) under various conditions, there is a need for an amylase having an altered stability and/or activity profile. This altered stability (oxidative, thermal or pH performance profile) can be achieved while maintaining adequate enzymatic activity, as compared to the wild-type or precursor enzyme. The characteristic affected by introducing such mutations may be a change in oxidative stability while maintaining thermal stability or vice versa. Additionally, the substitution of different amino acids for an oxidizable amino acids in the alpha-amylase precursor sequence or the deletion of one or more oxidizable amino acid(s) may result in altered enzymatic activity at a pH other than that which is considered optimal for the precursor alpha-amylase. In other words, the mutant enzymes of the present invention may also have altered pH performance profiles, which may be due to the enhanced oxidative stability of the enzyme.

As used herein the term ‘amylase’ also relates to all forms of alpha-amylase enzymes including alpha-amylase mutants that are the expression product of a mutated DNA sequence encoding an alpha-amylase, wherein the mutant alpha-amylases, in general, are obtained by in vitro modification of a precursor DNA sequence encoding a naturally occurring or recombinant alpha-amylase to encode the substitution or deletion of one or more amino acid residues in a precursor amino acid sequence.

Amylase-producing organisms include animals, plants, algae, fungi, archaebacteria and bacteria. Genes coding for α-amylase have been isolated and characterised. By way of example, EP-B-0470145 discloses the nucleotide sequence of α-amylase in potato plants. α-amylase is encoded by a gene family consisting of at least 5 individual genes, which, based on their homology, can be divided into two subfamilies, type 3 amylase(s) and type 1 amylase(s). In, for example, potato plants the two groups of α-amylases are expressed differently; type 3 α-amylases are expressed in root, in tubers, in sprouts and in stem tissue; whereas type 1 α-amylases are expressed in sprout and stem tissues.

To date, no one has suggested the use of a component comprising an enzyme which has amylase activity and which is capable of degrading resistant starch for use in a feed comprising starch. By way of example, reference can be made to the following teachings.

Taniguchi et al. (26) describe a Bacillus circulans F2 amylase which is -much more efficient in degrading native potato starch at 37° C. than porcine pancreas amylase and Streptococcus bovis amylase, both of which are mentioned as having high activities on native starch. All three enzymes perform very similar on corn starch. The Bacillus amylase has a raw starch binding domain and proteolytic removal of this domain reduces the activity on raw potato starch to 17% (17).

Likewise, a raw starch binding domain of a Cryptococcus sp. S-2 amylase is essential for its ability to bind to and degrade raw starch (14). On raw wheat and corn starch the Cryptococcus amylase has the same activity as porcine pancreas amylase whereas Aspergillus oryzae amylase has 15 times less activity. On raw potato starch the Cryptococcus amylase has three times higher activity than porcine pancreas amylase and more than 70 times higher activity than Aspergillus oryzae amylase. The Cryptococcus amylase is thermostable (50% survival after 30 min. at 80° C. without substrate and with 2 mM CaCl₂) and has >50% activity at pH 3 (pH optimum at 6).

In 1992, Gruchala and Pomeranz (12) showed a difference in the ability of different amylases to degrade resistant starch. Amylomaize was cooked in order to increase the amount of retrograded resistant starch. Hereafter a known amount of resistant starch was treated with two different amylases for 12 hours at 60° C., the suspension was filtered, and the residual amount of starch was measured and compared to a control (treatment without addition of amylase). They found that a heat stable α-amylase from Bacillus licheniformis was able to solubilise 16% of the resistant starch, whereas an amylase from Aspergillus sp. K-27 solubilised 41% of the resistant starch.

### Raw Starch Degrading Amylases

The amylases for use in the present invention include raw starch degrading amylases.

Raw starch degrading amylases may comprise a starch binding domain and have been found to be comparable to porcine pancreas amylase when degrading raw starch such as that found in native corn and wheat starch, but superior on potato or other starches which are more resistant to degradation.

Cyclodextrin glycosyl transferases (CGTase) degrade starch by formation of cyclodextrins, by hydrolysis and disproportionation/transglycosylation similar to conventional amylases. CGTases have been reported to be raw starch degrading (25)(27).

The CGTase related maltogenic amylase Novamyl™ (Novo Nordisk A/S) may be used for maltose production from raw starch (4).

Furthermore, in some applications CGTases may be used for starch liquefaction instead of liquefying amylases like B. licheniformis amylase (Termamyl™, Novo Nordisk A/S) or used B. amyloliquefaciens amylase.

A CGTase derived from Thermoanaerobactedum thertnosulfurogenes (Toruzyme™ Novo Nordisk A/S), is highly thermostable and can survive at 90° C. for hours in the presence of starch.

Aspergillus sp. K-27 amylase and porcine pancreas amylases degrade native wheat and corn starch similarly, whereas Aspergillus sp. K-27 amylase is much more efficient than the latter enzyme in degrading native potato and high-amylose maize starch (21).

Suitable amylases may also include Pseudomonas saccharophila maltotetroase producing amylase and homologous Glucan 1,4-aplha-maltotetrahydrolases of EC 3.2.1.60.

Preferably, the amylase enzyme is derived and/or isolated from Bacillus circulans F2 amylase, Streptococcus bovis amylase, Cryptococcus S-2 amylase, Aspergillus K-27 amylase, Bacillus licheniformis amylase and Thermomyces lanuginosus amylase.

T. lanuginosus amylases are disclosed for example in PCT publication WO 9601323 and in Enzyme Microbiol. Technol. (1992), 14,112-116).

### Amylase Activity

As used herein the term ‘amylase activity’ relates to any enzyme capable of hydrolysing or degrading starch—such as resistant starch and/or starch degradation products.

The ability of different amylases to degrade resistant starch can measured by techniques well known in the art, such as the method of Gruchala and Pomeranz (12) wherein the residual amount of starch after degradation with different amylases was measured and provided significant differences.

Typically, amylase activity on resistant starch may be measured using methods based on, for example, Englyst et al. (9);(8), Silvester et al. (24) and Morales et al (18). Such methods employ an in vitro digestion method that simulates the human digestive system prior to the large intestine.

### Starch Binding Domain

The amylase for use in the present invention may comprise a starch-binding domain.

As used herein the term “starch binding domain” is meant to define all polypeptide sequences or peptide sequences having affinity for binding to starch.

Starch binding domains may include single unit starch binding domains, starch binding domains isolated from microorganisms, such as bacteria, filamentous fungi or yeasts, or starch binding domains of a starch binding protein or a protein designed and/or engineered to be capable of binding to starch.

Starch binding domains may be useful as a single domain polypeptide or as a dimer, a trimer, or a polymer; or as a part of a protein hybrid. A single unit starch binding domain may also be referred to as “isolated starch binding domain” or “separate starch binding domain”

A single unit starch binding domain includes up to the entire part of the amino acid sequence of a single unit starch binding domain-containing enzyme, e.g. a polysaccharide hydrolyzing enzyme, being essentially free of the catalytic domain, but retaining the starch binding domain (s). Thus the entire catalytic amino acid sequence of a starch degrading enzyme (e.g. a glucoamylase) or other enzymes comprising one or more starch binding domains is not to be regarded as a single unit starch binding domain.

A single unit starch binding domain may constitute one or more starch binding domains of a polysaccharide hydrolyzing enzyme, one or more starch binding domains of a starch binding protein or a protein designed and/or engineered to be capable of binding to starch.

### Thermostable

Preferably, the enzyme having amylase activity and which is capable of degrading resistant starch is thermostable.

As used herein the term ‘thermostable’ relates to the ability of the enzyme to retain activity after exposure to elevated temperatures.

Preferably, the enzyme having amylase activity for use in the present invention is capable of degrading resistant starch at temperatures of from about 20° C. to about 50° C. Suitably, the enzyme retains its activity after exposure to temperatures of up to about 95° C.

### pH Stable

Preferably, the enzyme having amylase activity and which is capable of degrading resistant starch is pH stable.

As used herein the term ‘pH stable’ relates to the ability of the enzyme to retain activity over a wide range of pH's.

Preferably, the enzyme having amylase activity for use in the present invention is capable of degrading resistant starch at a pH of from about 3 to about 7.

### Substantially Resistant to Amylase Inhibition

The enzyme having amylase activity and which is capable of degrading resistant starch may be substantially resistant to amylase inhibition.

An important factor for the efficiency of amylases in starch digestion is their susceptibility towards amylase inhibitors from feed materials. Al-Kahtani has reported significant inhibition of a commercial Bacillus subtilis amylase as well as porcine pancreas amylase by extracts from soy bean (1). It has been reported that rye contains high amounts of amylase inhibitors which are effective against porcine pancreas amylase as well as B. licheniformis amylase (7). Structurally, B. licheniformnis amylase is closely related to B. amyloliquefaciens feed amylase. Likewise, the presence of amylase inhibitors in maize and most other feed plants have been reported (2).

As used herein the term ‘substantially resistant to amylase inhibition’ relates to the ability of the enzyme to maintain a level of activity sufficient to partially or wholly degrade resistant starch such as that produced from the degradation of a feed comprising starch.

### Capable of Degrading Resistant Starch

The enzyme for use in the present invention is capable of degrading resistant starch.

As used herein the term ‘degrading’ relates to the partial or complete hydrolysis or degradation of resistant starch to monosaccharides—such as glucose and/or oligosaccharides, for example disaccharides—such as maltose and/or dextrins.

The enzyme for use in the present invention may degrade residual resistant starch that has not been completely degraded by an animals amylase. By way of example, the enzyme for use in the present invention may be able to assist an animal's amylase (eg. pancreatic amylase—such as pancreatic α-amylase) in improving the degradation of resistant starch.

Pancreatic α-amylase is excreted in the digestive system by animals. Pancreatic α-amylase degrades starch in the feed. However, a part of the starch, the resistant starch, is not degraded fully by the pancreatic α-amylase and is therefore not absorbed in the small intestine (see definition of resistant starch).

The enzyme for use in the present invention is able to assist the pancreatic α-amylase in degrading starch in the digestive system and thereby increase the utilisation of starch by the animal.

The ability of an enzyme to degrade resistant starch may be analysed for example by a method developed and disclosed by Megazyme International Ireland Ltd. for the measurement of resistant starch, solubilised starch and total starch content of a sample (Resistant Starch Assay Procedure, AOAC Method 2002.02, MCC Method 32-40).

### Component

Suitably the component comprising an enzyme for use in the present invention is a foodstuff. As used herein the term “foodstuff” may include food ingredients suitable for animal consumption.

Typical food ingredients may include any one or more of an additive such as an animal or vegetable fat, a natural or synthetic seasoning, antioxidant, viscosity modifier, essential oil, and/or flavour, dye and/or colorant, vitamin, mineral, natural and/or non-natural amino acid, nutrient, additional enzyme (including genetically manipulated enzymes), a binding agent such as guar gum or xanthum gum, buffer, emulsifier, lubricant, adjuvant, suspending agent, preservative, coating agent or solubilising agent and the like.

Components for use in the present invention comprise an enzyme which has amylase activity or is capable of degrading resistant starch.

Typically the components of the present invention are used in the preparation of feeds for animal consumption by the indirect or direct application of the components of the present invention to the feed.

Examples of the application methods which may be used in the present invention, include, but are not limited to, coating the feed in a material comprising the component, direct application by mixing the component with the feed, spraying the component onto the feed surface or dipping the feed into a preparation of the component.

The component of the present invention is preferably applied by mixing the component with a feed or by spraying onto feed particles for animal consumption. Alternatively, the component may be included in the emulsion of a feed, or the interior of solid products by injection or tumbling.

### Application of Component

The component of the present invention may be applied to intersperse, coat and/or impregnate a feed with a controlled amount of an enzyme which has amylase activity or is capable of degrading resistant starch. Mixtures of components comprising an enzyme may also be used and may be applied separately, simultaneously or sequentially. Chelating agents, binding agents, emulsifiers and other additives such as micro and macro minerals, amino acids, vitamins, animal fats, vegetable fats, preservatives, flavourings, colourings, may be similarly applied to the feed simultaneously (either in mixture or separately) or applied sequentially.

### Amount of Component

The optimum amount of the component to be used in the present invention will depend on the feed to be treated and/or the method of contacting the feed with the component and/or the intended use for the same. The amount of enzyme used in the component should be in a sufficient amount to be effective to substantially degrade resistant starch following ingestion and during digestion of the feed.

Advantageously, the component comprising the enzyme would remain effective following ingestion of a feed for animal consumption and during digestion of the feed until complete digestion of the feed is obtained, i.e. the total calorific value of the feed is released.

### Preparing the Feed

Feeds may be prepared by techniques well known in the art, such as that described herein in Example 7.

A particularly suitable feed preparation for use in the present invention is feed which is in the form of pellets.

Particularly suitable amylase enzymes for use in the present invention must be efficient in degrading pelleted feed comprising resistant starch.

### Measuring Resistant Starch

Methods for determining the amount of starch resistant to hydrolysis are well known in the art.

For example the presence of a starch fraction resistant to enzymic hydrolysis was first recognized by Englyst et al. in 1982 (Analyst, 107, p.307-318, 1982) during their research on the measurement of non-starch polysaccharides (1). This work was extended by Berry (J. Cereal Science, 4, p.301-304, 1986) who developed a procedure for the measurement of resistant starch incorporating the α-amylase/pullulanase treatment employed by Englyst et al. (Analyst, 107, p.307-318, 1982), but omitting the initial heating step at 100° C., so as to more closely mimic physiological conditions. Under these conditions, the measured resistant starch contents of samples were much higher. This finding was subsequently confirmed by Englyst et al. (Am.J.Clin.Nutr, 42, p.778-787,1985; Am.J.Clin.Nutr. 44, p.42-50, 1986; Am.J.Clin.Nutr. 45, p.423431-1987) through studies with healthy ileostomy subjects.

By the early 1990's the physiological significance of resistant starch was fully realised. Several new/modified methods were developed during the European Research Program EURESTA (Englyst et al, European J.Clin.Nutr, 46, suppl.2, S33-S50). The Champ (Eur.J.Clin.Nutr. 46, suppl.2, S51-S62) method was based on modifications to the method of Berry (J. Cereal Science, 4, p.301-304, 1986) and gave a direct measurement of resistant starch using pancreatic a-amylase wherein incubations were performed at pH 6.9.

Muir and O'Dea (Muir, J. G. & O'Dea, K. (1992) Am. J. Clin. Nutr. 56, 123-127) developed a procedure in which samples were chewed, treated with pepsin and then by a mixture of pancreatic a -amylase and amyloglucosidase in a shaking water bath at pH 5.0, 37° C. for 15 hr. The residual pellet (containing resistant starch) was recovered by centrifugation, washed with acetate buffer by centrifugation and the resistant starch was digested by a combination of heat, DMSO and thermostable α-amylase treatments.

More recently, these methods have been modified by Faisant et al. (Faisant, N., Planchot, V., Kozlowski, F., M.-P. Pacouret, P. Colonna. & M. Champ. (1995) Sciences des Aliments, 15, 83-89), Goni et al. (Goni, I., Garcia-Diz, E., Manas, E. & Saura-Calixto, F. (1996), Fd. Chem., 56, 445-449), Akerberg et al. (Akerberg, A. K. E., Liljberg, G. M., Granfeldt, Y. E. Drews, A. W. & Bjorck, M.E. (1998), Am. Soc. Nutr. Sciences, 128, 651-660) and Champ et al. (Champ, M., Martin, L., Noah, L. & Gratas, M. (1999) In “Complex carbohydrates in foods (S. S. Cho, L. Prosky & M. Dreher, Eds.) pp. 169-187. Marcel Dekker, Inc., New York, USA). These modifications included changes in enzyme concentrations employed, types of enzymes used, sample pre-treatment (chewing), pH of incubation and the addition (or not) of ethanol after the α-amylase incubation step. All of these modifications will have some effect on the determined level of resistant starch in a sample.

Furthermore, Megazyme International Ireland Ltd. has developed an assay for the measurement of resistant starch, solubilised starch and total starch content in a sample (Resistant Starch Assay Procedure, AOAC Method 2002.02, AACC Method 32-40).

### Animal Performance

In a further aspect, the present invention relates to the use of an enzyme as described herein in the preparation of a feed to improve animal performance.

As used herein, the term “improving animal performance” refers to, for example, improving one or more features of an animal—such as improving growth or improving food conversion.

Animal performance may be measured using various methods known in the art—such as measuring growth, feed conversion ratios, and/or intake. Also the quality of the droppings₁ occurrence of death, amount of phosphate in bone etc. may also be measured as parameters of animal performance.

The invention will now be further described by way of Examples, which are meant to serve to assist one of ordinary skill in the art in carrying out the invention and are not intended in any way to limit the scope of the invention.

### EXAMPLES

### 1. Assay to Determine the Activity of Candidate Enzymes having Amylase Activity on feeds comprising starch.

Feed raw material such as wheat, soy or maize was taken and candidate enzyme added in addition to typical digestive enzymes.

Following in vitro digestion the amount of resistant starch was determined from the amount of residual (undigested) starch and compared to that of a control in the absence of a candidate amylase enzyme.

### 2. Determination of the Presence of Amylase Inhibitors in Feed Raw Materials.

The level of inhibition of samples of amylase candidates was determined using extracts from feed raw materials and a standard amylase assay. An increased amount of extract from feed raw materials was added to the assay and the level of inhibition calculated as a reduction in amylase activity.

Protocol for Assay of a-amylase Inhibitors

Definitions

One unit of amylase activity catalyses hydrolysis of one micromole glycosidic linkages in one minute under the conditions described.

Inhibition is measured in % and is the relative reduction of activity as compared to the activity of a non-inhibited amylase solution.

Reagents

Substrate: Phadebas Amylase Test-tablet for in vitro diagnostic use (Pharmacia Diagnostics).

Reagent solution: (9.0 g of sodium chloride, 2.0 g of bovine serum albumin and 2.2 g of calcium chloride dissolved in distilled water to 1000 ml total volume).

Double concentrated reagent solution: (9.0 g of sodium chloride, 2.0 g of bovine serum albumin and 2.2g of calcium chloride dissolved in distilled water to 500 ml total volume).

Extract from test material containing possible inhibitors: (sample is ground finely and about 2 g is mixed with 10 ml of cold water for 10 min, there after the slurry is filtered.) 0.5 M NaOH solution

Filter Paper

Spectrophotometer to measure absorbance at 640 nm

Sample of the tested enzyme

Procedure

Test enzyme sample

0.2 ml of diluted enzyme in reagent solution and 4.0 ml of reagent solution were pipetted into a test tube and equilibrated at +37° C. for 5 minutes. The substrate tablet was added with pincers, mixed well for 10 seconds and incubated at +37° C. for 15 minutes. The start time of the reaction was recorded on addition of the tablet. 1.0 ml of 0.5 M NaOH solution was added and stirred well. The solution was filtered or centrifuged at 3500 rpm for 10 minutes and the absorbance measured against a reagent blank at 620 nm. The absorbance of the enzyme sample was generally between 0.3-0.5.

Test of Inhibition:

The same procedure as described above was conducted for test enzyme samples, however, 2.0 ml of double concentrated reagent solution and 2.0 ml of extract from test material containing possible inhibitors was used instead of 4.0 ml reagent solution.

Reagent Blank 4.2 ml of reagent solution were equilibrated at +37° C. for 5 min. The substrate tablet was added with pincers, stirred well for 10 seconds, then incubated at +37° C. for 15 minutes. 1.0 ml of 0.5 M NaOH solution was added and stirred well. The solution was filtered or centrifuged at 3500 rpm for 10 minutes.

### Calculation

The absorbance of the sample was proportional to α-amylase activity. The amylase activity of each enzyme dilution was determined from the calibrated table enclosed with the tablet kit. The amylase activity of the sample was calculated as follows:

$$Activity ( U \text{/} g ) = \frac{Act * Df}{1000}$$

where
Act=amylase activity value (expressed U/litre) of enzyme dilution read from
Phadebas Amylase Test table
Df=dilution factor (ml/g)
1000=factor for conversion of litre to ml

Activity was calculated both for the pure enzyme and for test samples containing material extract. The inhibition of the extract was determined as the reduction in activity when the extract was added as a percentage of the activity of the pure enzyme.

$$Inhibition = \frac{Activity of enzyme with extract}{Activity of pure enzyme * 100 \%}$$

3. Determination of the Quantity of Resistant Starch

Starch samples having low water content were milled to pass through a 1 mm sieve. Samples having a fat content of >5% were defatted (using petroleum-ether extraction) prior to milling. The samples were then directly homogenized and placed in centrifuge tubes for analysis.

100 mg of dry milled sample were placed into a 50-ml centrifuge tube and 10 ml of KCl-HCl buffer pH 1.5 added (adjustment with 2 M HCl or 0.5 M NaOH). For wet samples, a portion weighing the equivalent to 100 mg of dry matter was added to KCl-HCl buffer pH 1.5, homogenised and placed into a centrifuge tube. 0.2 ml of pepsin solution (1 pepsin/10ml buffer KCl-HCl) were added, mixed and the tube left in a water bath at 40° C. for 60 min with constant shaking. Following incubation at 40° C. the samples were removed and left to cool at room temperature. 9 ml of 0.1 M Tris-maleate buffer, pH 6.9 were added (pH adjustment with 2 M HCl or 0.5 M NaOH) and 1 ml of the α-amylase solution (40 mg α-amylase per ml Tris-maleate buffer). After mixing the samples were incubated for 16 h in a water bath at 37° C. with constant shaking. The samples were subsequently centrifuged (15 min, 3000 g) and the supematants discarded.

3 ml of distilled water were added to the residue, carefully moistening the sample. 3 ml of 4 M KOH were added and the samples mixed and left for 30 min at room temperature with constant shaking. 5.5 ml of 2 M HCl and 3 ml of 0.4 M sodium acetate buffer, pH 4.75 were added (pH adjustment with 2 M HCI or 0.5 M NaOH) followed by 80 μl of amyloglucosidase. Following mixing the samples were left for 56 min in a water bath at 60° C. with constant shaking.

The samples were centrifuged (15 min, 3000 g), and the supematant collected. The residues were washed at least once with 10 ml of distilled water, centrifuged again and the supernatant combined with that obtained previously.

3.1. Preparation of a Standard Curve to Determine Glucose Concentrations (10-60 ppm)

0.5 ml of water, sample and standard were pipetted into test tubes. 1 ml of the reagent from a glucose determination kit (GOD-PAP) was added. The solutions were mixed and left for 30 min in a water bath at 37° C.

Between 5 and 45 minutes after incubation the absorbance of the samples and standards was read at 500nm against a reagent blank. The glucose concentration of the samples was calculated using a standard curve constructed from the absorbencies of standards having known glucose concentrations (10-60 ppm). The resistant starch concentration of the test sample was calculated as mg of glucose ×0.9.

### 4. Measurement of Resistant Starch in Pure Starches and Plant Materials

4.1 Preparation of Test Samples

50 g of sample of grain or malt was ground in a grinding mill to pass through a 1.0 mm sieve. Fresh samples (e.g. canned beans, banana, potatoes) were minced in a hand operated meat mincer to pass through a 4 mm screen. The moisture content of dry samples was determined by the AOAC Method 925.10 (14), and that of fresh samples was determined by lyophilisation followed by oven drying according to AOAC Method 925.10.

4.2 Measurement of Resistant Starch

100 mg samples were weighed directly into screw cap tubes. 4.0 ml of pancreatic α-amylase (10 mg/ml) containing AMG (3 U/ml) in sodium maleate buffer (pH6) were added to each tube. Following mixing the samples were incubated at 37° C. with continuous shaking (200 strokes/min). After 16 hr the samples were treated with 4.0 ml of IMS (99% v/v) and centrifuged at 3,000 rpm for 10 min. The supernatants were decanted and the pellets re-suspended in 2 ml of 50% IMS with vigorous stirring on a vortex mixer. 6 ml of 50% IMS were added and mixed, and the tubes centrifuged at 3,000 rpm for 10 min. The suspension and centrifugation step were repeated. 2 ml of 2 M KOH were added to each tube and the pellets re-suspended (dissolving the resistant starch) by stirring for approx. 20 min in an ice/water bath. Each tube was treated with 8 ml of 1.2M sodium acetate buffer (pH 3.8) with stirring. 0.1 ml of AMG (3200 U/ml) was added immediately and the tubes placed in a water bath at 50° C. for 30 min with continual mixing.

Samples containing >10% resistant starch were transferred to a 100 ml volumetric flask (using a water wash bottle) and adjusted to volume with water. Aliquots of the solution were centrifuged at 3,000 rpm for 10 min.

Samples containing <10% resistant starch (without dilution) were centrifuged at 3,000 rpm for 10 min.

0.1 ml aliquots (in duplicate) of either the diluted or undiluted supematants were transferred into glass test tubes (16×100 mm), treated with 3.0 ml of GOPOD reagent (Glucose Oxidase-Peroxidase-aminoantipyrine buffer mixture—a mixture of glucose oxidase, >12000 U/L; peroxidase, >650 U/L; and 4-aminoantipyrine, 0.4 mM in phosphate buffer pH 7.4) and incubated at 50° C. for 20 min.

Reagent blank solutions were prepared by mixing 0.1 ml of 0.1 M sodium acetate buffer (pH 4.5) and 3.0 ml of GOPOD reagent. Glucose standards were prepared (in quadruplicate) by mixing 0.1 ml of glucose (1 mg/ml) and 3.0 ml of GOPOD reagent. After incubation at 50° C. for 20 min, the absorbance of each solution was measured at 510 nm against the reagent blank.

4.3 Calculations

The resistant starch content (%, on a dry weight basis) in test samples was calculated as follows:

For samples containing >10% resistant starch:
=ΔE×F×100/0.1×1/1000×100/W×162/180
=ΔE×F/W×90.

For samples containing <10% resistant starch:
=ΔE×F×10.3/0.1×1/1000×100/W×162/180
=ΔE×F/W×9.27.
where:

ΔE=absorbance (reaction) read against the reagent blank;

F=conversion from absorbance to micrograms=100 (μg of glucose)/absorbance of

100 μg of glucose;

100/0.1=volume correction (0.1 ml taken from 100 ml); 1/1000=conversion from micrograms to milligrams;

W=dry weight of sample analysed [=“as is” weight×(100-moisture content)/100];

100/W=factor to present starch as a percentage of sample weight;

162/180=factor to convert from free glucose, as determined, to anhydro-glucose as occurs in starch;

10.3/0.1=volume correction (0.1 ml taken from 10.3 ml) for samples containing 0-10% resistant starch where the incubation solution is not diluted and the final volume is˜10.3 ml.

### 5. Measurement of Degraded Raw Starch

In this example, the ability to assist pancreatic α-amylase in degrading raw starch of two enzymes having amylase activity was determined. The enzymes were Bacillus amyloloquefaciens amylase (LTM, Genencor International Inc.) and Thernomyces lanuginosus amylase, disclosed in WO09601323.

5.1. Principle

This analysis is based on Resistant Starch Assay Kit (Cat. no. K-RSTAR) from

Megazyme (Megazyme International Ireland Limited). The principle of Resistant Starch Assay Procedure (AOAC Method 2002.02 AACC Method 32-40) has been modified for the purposes of this example so that incubation time is only 1.5 hr instead of 16 hr.

Samples were incubated in a shaking water bath with pancreatic α-amylase and amyloglucosidase (AMG) and optionally with Bacillus amyloloquefaciens amylase (LTM, Genencor International Inc.) or Thermnomyces lanuginosus amylase for 1.5 hr at 37° C., during which time, starch was solubilised and hydrolyzed to glucose by the combined action of the enzymes. The reaction was terminated by the addition of an equal volume of industrial methylated spirits (IMS, denatured ethanol). The solublised starch in the supernatant was quantitatively hydrolyzed to glucose with AMG. Glucose was measured with oxidase/peroxidase reagent (GOPOD). This is a direct measure of the solublised starch content of the sample.

The units of Bacillus amyloloquefaciens amylase (LTAA) or Thernomyces lanuginosus amylase were measured by the Phadebas® amylase test (Pharmacia & Upjohn).

5.2. Measurement of Easily Degradable Starch.

100 mg samples were weighed directly into screw cap tubes (Corning culture tube; 16×125 mm). 4.0 ml of pancreatic α-amylase (10 mg/ml) containing AMG (3 U/ml), and optionally 0.4 U in total of B. amyloloquefaciens amylase or T. lanuginosus amylase in sodium maleate buffer were added to each tube. Following mixing the samples were incubated at 37° C. with continuous shaking (200 strokes/min) for 1.5 hr. After 1.5 hr the samples were treated with 4.0 ml of IMS (99% v/v) with vigorous stirring on a vortex mixer and centrifuged at 3,000 rpm for 20 min. The supernatants were decanted into 100 ml volumetric flasks and filled up to 100 ml with demineralised water. A sample of 2 ml was taken and 0.2 ml of AMG (3200 U/ml) was added to it. The tubes were placed in a water bath at 50° C. for 30 min with continual mixing.

0.1 ml aliquots of either the diluted or undiluted supernatants were transferred into glass test tubes (16×100 mm), treated with 3.0 ml of GOPOD reagent and incubated at 50° C. for 20 min. Reagent blank solutions were prepared by mixing 0.1 ml of 0.1 M sodium acetate buffer (pH 4.5) and 3.0 ml of GOPOD reagent. Glucose standards were prepared (in quadruplicate) by mixing 0.1 ml of glucose (1 mg/ml) and 3.0 ml of GOPOD reagent. After incubation at 50° C. for 20 min, the absorbance of each solution was measured at 510 nm against water.

5.3. Calculations

The content of starch which has been solubilised (%, on dry weight basis) in the samples was calculated as follows:
=ΔE×G×D×100/0.1×1.1×1/1000×100W×162/180
=ΔE×(G×D)W×99.
where: ΔE=absorbance (reaction) read against the reagent blank; G=conversion from absorbance to micrograms=100 (μg of glucose)/absorbance of 100 μg of glucose; D=dilutions of the supematant; 100/0.1=volume correction (0.1 ml taken from 100 ml); 1.1 =dilution when AMG is added to the sample after 1.5 h incubation, 1/1000=conversion from micrograms to milligrams; 162/180=factor to convert from free glucose, as determined, to anhydro-glucose as occurs in starch.

### 5.4. The Results

Firstly, the action of B. amyloloquefaciens amylase was analysed and compared with a reference containing only a pancreatic α-amylase and amyloglucosidase (AMG). The amount (%) of soluble starch in the samples after the treatment are presented in Table 1.

TABLE 1

| | No enzyme | 0,4 u LTAA |
|---|---|---|
| | 48.97 | 49.45 |
| | 51.02 | 49.51 |
| | | 50.09 |
| | | 52.27 |
| average: | 49.995 | 50.33 |

These results indicate that LTM does not have any additive effect in degrading insoluble starch compared to pancreatic α-amylase and AMG alone.

Secondly, the action of B. amyloloquefaciens amylase was analysed and compared with the action of T. lanuginosus amylase. The amount (%) of soluble starch in the samples after the treatment of B. amyloloquefaciens amylase and T lanuginosus amylase are presented in Table 2.

TABLE 2

| | 0,4 u LTAA | 0,4 u thermomyces |
|---|---|---|
| | 49.45 | 53.99 |
| | 49.51 | 56.03 |
| | 50.09 | 55.98 |
| | 52.27 | 56.64 |
| average | 50.33 | 55.66 |

These results indicate that T lanuginosus amylase has an additive effect in degrading insoluble starch (the means are a significant difference with a confidence level of 99%).

### 6. Preparation of Animal Feed

A typical feed was prepared from the following ingredients:

| | |
|---|---|
| Corn | 57.71% |
| Soy bean meal 48 | 31.52% |
| Soy oil | 6.30% |
| NaCl | 0.40% |
| DL Methionine | 0.20% |
| Dicalcium phosphate | 1.46% |
| Vitamin/mineral mix | 1.25% |
| Total | 100% |

The feed mixture was heated by injecting steam to give a temperature of 80° C. for 30 seconds and further pelleted in a pelletiser. The pellets were subsequently dried.

This process is typical for the feed industry to obtain a pelleted feed.

### 7. Effect of Addition of Amylase Enzyme to Animal Feed Comprising Starch

7.1 Feeding Trial—Pigs

Diets

Control pigs were fed a commercial diet, while five experimental diets were supplied with 1-10 U of exogenous amylases per gram of fodder. Diets were offered on an ad libitum basis. Water was also available ad libitum from nipple drinkers located in each holding pen. Each diet had a starter and grower phase. Pigs were allocated to one of the 6 treatments and each diet combination (starter and grower) was fed to 6 replicates.

Animals/Housing

36 female piglets obtained at weaning (live weight range 7.5-9kg) from a commercial unit were used. Pigs were housed in individual pens.

Procedure

Animals were, on arrival, individually weighed, transferred immediately to the experimental unit, housed in the appropriate numbered holding pen and allocated to a control or an experimental starter diet. Pigs were thereafter weighed every 7 days.

Pigs were fed on an ad libitum basis and fodder consumed from day 0 was recorded on a weekly basis. When the pigs weighed 16.0 kg or above they were transferred to a grower diet. Feed intake and weight was recorded weekly. Animals were inspected twice daily at feeding time. Health, cleanness and any other relevant observations were recorded. The trial concluded when the piglets reached a weight of 27.5 kg.

The growth rate, feed intake and feed conversion ratio were thus determined in piglets between approximately 10 and 25 kg live weight.

Conclusion

Animals fed experimental diets containing resistant starch degrading amylase showed a marked decrease in feed conversion ratio (FCR) indicating that less feed is needed to achieve a given weight increase as compared to controls. Pigs fed experimental diets also showed a marked increase in growth rate and a decrease in feed intake.

7.2 Feeding Trial—Broilers

Diets

Control animals were fed a commercial diet, while the five experimental diets were supplied with 1-10 U exogenous amylases per gram fodder. Diets were offered on an ad libitum basis. Water was available ad libitum. Each diet had a starter and grower phase.

Animals

Broilers were allocated to one of the 6 diets and each diet combination (starter and grower) was fed to 8 replicates of 42 animals each. Animals were inspected regularly. Health, cleanness and any other relevant observations were recorded.

Procedure

Animals were weighed on arrival, transferred immediately to the experimental unit, housed in the appropriate numbered holding pen and allocated to an experimental diet. Broilers were weighed after 20 and 40 days. The use of fodder after 20 and 40 days was also recorded. Growth rate, feed intake and feed conversion ratio were determined.

Conclusion

Animals fed experimental diets containing resistant starch degrading amylase showed a marked decrease in feed conversion ratio (FCR) indicating that less feed is needed to achieve a given weight increase as compared to controls.

Broilers fed experimental diets also showed a marked increase in growth rate and a decrease in feed intake.

### Summary Aspects of the Invention

In a broad aspect, the present invention relates to a component for use in a feed comprising starch wherein said component comprises an enzyme; wherein the enzyme has amylase activity and is capable of degrading resistant starch.

In another broad aspect, the present invention relates to a method of degrading resistant starch in a feed comprising contacting said resistant starch with an enzyme having amylase activity and which is capable of degrading said resistant starch.

Other Aspects of the Invention

Other aspects of the present invention wil now be described by way of numbered paragraphs.

1. A component for use in a feed comprising starch wherein said component comprises an enzyme; wherein the enzyme has amylase activity and is capable of degrading resistant starch and wherein the enzyme comprises one or more of the following characteristics:
a. a starch binding domain
b. is thermostable
c. is pH stable
d. is substantially resistant to amylase inhibitors.

2. A component according to paragraph 1 wherein the enzyme comprises a starch binding domain.

3. A component according to paragraph 1 or paragraph 2 wherein the enzyme is thermostable.

4. A component according to paragraphs 1, 2 or 3 wherein the enzyme is pH stable.

5. A component according to any one of the preceding paragraphs wherein the enzyme is substantially resistant to amylase inhibitors.

6. A component according to any one of the preceding paragraphs wherein the enzyme is a raw starch degrading enzyme.

7. A component according to any one of the preceding paragraphs wherein the enzyme is a cyclodextrin glycosyl transferase (CGTase).

8. A component according to paragraph 7 wherein the CGTase is derivable from Thermoanaerobacterium thermosulfurogenes.

9. A component according to paragraph 7 or paragraph 8 wherein the CGTase is Toruzyme®.

10. A component according to paragraph 7 wherein the CGTase is a maltogenic amylase such as Novamyl®.

11. A component according to paragraph 1 wherein the enzyme is an amylase enzyme selected from the group consisting of Bacillus circulans F2 amylase, Streptococcus bovis amylase, Cryptococcus S-2 amylase,. Aspergillus oryzae amylase, Aspergillus K-27 amylase, Bacillus licheniformis amylase, Bacillus subtilis amylase and Bacillus amyloliquefaciens amylase.

12. A component according to paragraph 11 wherein the enzyme is a liquefying amylase such as Bacillus licheniformis amylase (Termamyl) or Bacillus amyloliquefaciens amylase.

13. A component for use in a feed according to any one of the preceding paragraphs wherein the feed is a feed for swine or poultry.

14. A component for use in a feed according to paragraph 13 wherein the feed is a raw material such as a legume or a cereal.

15. A feed comprising a starch and an enzyme; wherein the enzyme has amylase activity and is capable of degrading resistant starch and wherein the enzyme comprises one or more of the following characteristics:
a. a starch binding domain
b. is thermostable
c. is pH stable
d. is substantially resistant to amylase inhibitors.

16. A feed according to paragraph 15 wherein the enzyme comprises a starch binding domain.

17. A feed according to paragraph 15 or paragraph 16 wherein the enzyme is thermostable.

18. A feed according to paragraphs 15, 16 or 17 wherein the enzyme is pH stable.

19. A feed according to any one of paragraphs 15 to 18 wherein the enzyme is substantially resistant to amylase inhibitors.

20. A feed according to any one of paragraphs 15 to 19 wherein the enzyme is a raw starch degrading enzyme.

21. A feed according to any one of paragraphs 15 to 20 which is a feed for swine or poultry.

22. A feed according to paragraph 21 which is a raw material such as a legume or a cereal.

23. A method of degrading resistant starch in a feed comprising contacting said resistant starch with an enzyme having amylase activity and which is capable of degrading said resistant starch wherein the enzyme comprises one or more of the following characteristics:
a. a starch binding domain
b. is thermostable
c. is pH stable
d. is substantially resistant to amylase inhibitors.

24. A method according to paragraph 23 wherein the enzyme comprises a starch binding domain.

25. A method according to paragraph 23 or paragraph 24 wherein the enzyme is thermostable.

26. A method according to paragraphs 23, 24 or 25 wherein the enzyme is pH stable.

27. A method according to any one of paragraphs 23 to 26 wherein the enzyme is substantially resistant to amylase inhibitors.

28. A method according to paragraphs 23 to 27 wherein the enzyme is a raw starch degrading enzyme.

29. A method according to paragraphs 23 to 28 wherein the feed is a feed for swine or poultry.

30. A method according to paragraph 29 wherein the feed is a raw material such as a legume or a cereal.

31. Use of an enzyme in the preparation of a feed comprising a starch, to degrade resistant starch, wherein the enzyme has amylase activity and is capable of degrading said resistant starch and wherein the enzyme comprises one or more of the following characteristics:
a. a starch binding domain
b. is thermostable
c. is pH stable
d. is substantially resistant to amylase inhibitors.

32. Use of an enzyme in the preparation of a feed to improve the amount of energy derivable from said feed, wherein the enzyme has amylase activity and is capable of degrading resistant starch.

33. A process for preparing a feed comprising admixing a starch and an enzyme, wherein the enzyme has amylase activity and is capable of degrading resistant starch.

34. A process for identifying a component for use in a feed, wherein said component comprises an enzyme, said process comprising contacting resistant starch with a candidate component and determining the extent of degradation of said resistant starch; wherein said enzyme has amylase activity and is capable of degrading said resistant starch and wherein the enzyme comprises one or more of the following characteristics:
a. a starch binding domain
b. is thermostable
c. is pH stable
d. is substantially resistant to amylase inhibitors.

All publications mentioned in the above specification are herein incorporated by reference. Various modifications and variations of the described methods and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

### References

1. Al-Kahtani, H. A., (1999) Some antinutritional factors in Moringa peregrina (Al-Yassar or Al-Ban) and soybean products. Journal of Food Science vol 60. pp.395-398.

2. Buonocore, V., and Silano, V., (1986) Biochemical, nutritional, and toxicologisal aspects of alpha-amylase inhibitors from plant foods. In: Nutritional and toxicological significance of enzyme inhibitors in foods, M. Friedman, Ed. (Plenum Press, New York), p. 483.

3. Champ, M. and Faisant, N. 1996. Resistant starch. In: Carbohydrates as organic raw materials, vol. 3, (H. Van Bekkum, Ed. ) pp.189-215.

4. Christophersen, C., Pedersen, S., and Christensen, T., (1993) Method for production of maltose an a limit dextrin, the limit dextrin, and use of the limit dextrin. Denmark. WO 95/10627.

5. Colonna, P., Leloup, V., and Buléon, A., (1992) Limiting factors of starch hydrolysis. European Journal of Clinical Nutrition vol 46. pp.517-532.

6. De Schrijver, R., Vanhoof, K., and Vande Ginste, J., (1999) Nutrient utilization in rats and pigs fed enzyme resistant starch. Nutrition Research vol 19. pp.1349-1361.

7. Dojczew, D., Andrzejczuk-Hydel, J., and Kaczkowski, J., (1986) The protein inhibitors of amylases and peptidases isolated from cereal grains. Die Nahrung vol 30. pp.275-279.

8. Englyst, H. N., Kingman, S. M., and Cummings, J., (1992) Classification and measurement of nutritionally important starch fractions. European Journal of Clinical Nutrition vol 46. pp.S33-S50.

9. Englyst, H. N., Kingman, S. M., Hudson, G. J., and Cummings, J. H., (1996) Measurement of resistant starch in vitro and in vivo. British Journal of Nutrition vol 75. pp.749-755.

10. Goñi, I., Garcia-Diz, L., Mañas, E., and Saura-Calixto, F., (1996) Analysis of resistant starch: A method for foods and food products. Food Chemistry vol 56. pp.445-449.

11. Gordon, D. T., Topp, K., Shi, Y.-C., Zallie, J., and Jeffcoat, R., (1997) Resistant starch: physical and physiological properties. In: Frontiers in Feed and Feed Ingredients, p. 157.

12. Gruchala, L., and Pomeranz, Y., (1992) Raw-starch degrading amylase(s) affect enzyme-resistant starch. Journal of Food Science vol 57. pp.1433-1434.

13. Haralampu, S. G., (2000) Resistant starch—a review of the physical properties and biological impact of resistant starch3. Carbohydrate Polymers vol 41. pp.285-292.

14. lefuji, H., Chino, M., Kato, M., and limura, Y., (1996) Raw-starch-digeston and thermostable □-amylase from the yeast Cryptococcus sp. S-2: purification, characterization, cloning and sequencing. Biochemical Journal vol 318. pp.989-996.

15. Ito, T., Saito, K., Sugawara, M., Mochida, K., and Nakakuki, T., (1999) Effect of raw and heat-moisture treated high-amylose corn starches on the process of digestion in the rat digestive tract. Journal of the Science of Food and Agriculture vol 79. pp.1203-1207.

16. Jenkins, D. J. A., Kendall, C. W. C., (2000) Resistant starches. Current Opinion In Gastroenterology vol 16. pp.178-183.

17. Kim, C.-H., Kwon, S.-T., Taniguchi, H., and Lee, D. S., (1992) Proteolytic modification of raw-starch-digesting amylase from Bacillus circulans F-2 with subtilisin: separation of the substrate-hydrolytic domain and the raw substrate-adsorbable domain. Biochim Biophys Acta vol 1122. pp.243-250.

18. Morales, M. D., Escarpa, A., González, M. C., and de Henares, A., (1997) Simultaneous determination of resistant and digestible starch in foods and food products. Starch vol 49. pp.448-453.

19. Moran, E. T. jr., (1982) Starch digestion in fowl. Poultry Science vol 61. pp.1257-1267.

20. Muir, J. G., Birkett, A., Brown, I., Jones, G., and Odea, K., (1995) Food-processing and maize variety affects amounts of starch escaping digestion in the small intestine. American Journal Of Clinical Nutrition vol 61. pp.82-89.

21. Planchot, V., Colonna, P., Gallant, D. J., and Bouchet, B., (1995) Extensive degradation of native starch granules by alpha—amylase from Aspergillus fumigatus. Journal of Cereal Science vol 21. pp.163-171.

22. Ranhotra, G. S., Gelroth, J. A., and Glaser, B. K., (1996) Energy value of resistant starch. Journal of Food Science vol 61. pp.453455.

23. Roe, M., Brown, J., Faulks, R., and Livesey, G., (1996) Is the rat a suitable model for humans on studies of cereal digestion. European Journal of Clinical Nutrition vol 50. pp.710-712.

24. Silvester, K. R., Englyst, H. N., and Cummings, J. H., (1995) Ileal recovery of starch from whole diets containing resistant starch measured in vitro and fermentation of ileal effluent. American Journal Of Clinical Nutrition vol 62. pp.401-411.

25. Spreinat, A., and Antranikian, G., (1992) Analysis of the amylolytic enzyme system of Clostridium thermosulfurogenes EM1: Purification and synergistic action of pullulanases and maltohexaose forming □-amylase. Starch vol 44. pp.305-312.

26. Taniguchi, H., Jae, C. M., Yoshigi, N., and Maruyama, Y., (1983) Purification of Bacillus circulans F-2 amylase and its general properties. Agricultural and Biological Chemistry vol 47. pp.511-519.

27. Yamamoto, K., Zhang, Z. Z., and Kobayashi, S., (2000) Cycloamylose (cyclodextrin) glucanotransferase degrades intact granules of potato raw starch. Journal of Agricultural and Food Chemistry vol 48. pp.962-966.

1. A component for use in a feed comprising starch wherein said component comprises an enzyme; wherein the enzyme has amylase activity and is capable of degrading resistant starch.

2. A component according to claim 1 wherein the enzyme is thermostable.

3. A component according to claim 1 or claim 2 wherein the enzyme is pH stable.

4. A component according to any one of the preceding claims wherein the enzyme is a raw starch degrading enzyme.

5. A component according to any one of the preceding claims wherein the enzyme is an amylase enzyme selected from the group consisting of Bacillus circulans F2 amylase, Streptococcus bovis amylase, Cryptococcus S-2 amylase, Aspergillus K-27 amylase, Bacillus licheniformis amylase and Thermomyces lanuginosus amylase.

6. A component according to any one of the preceding claims wherein the feed is a feed for swine or poultry.

7. A component according to claim 6 wherein the feed is a raw material such as a legume or a cereal.

8. A feed comprising a starch and an enzyme; wherein the enzyme has amylase activity and is capable of degrading resistant starch.

9. A feed according to claim 8 wherein the enzyme is thermostable.

10. A feed according to claim 8 or claim 9 wherein the enzyme is pH stable.

11. A feed according to any one of claims 8 to 10 wherein the enzyme is a raw starch degrading enzyme.

12. A feed according to any one of claims 8 to 11 which is a feed for swine or poultry.

13. A feed according to claim 12 which is a raw material such as a legume or a cereal.

14. A method of degrading resistant starch in a feed comprising contacting said resistant starch with an enzyme having amylase activity and which is capable of degrading said resistant starch.

15. A method according to claim 14 wherein the enzyme is thermostable.

16. A method according to claim 14 or claim 15 wherein the enzyme is pH stable.

17. A method according to any one of claims 14 to 16 wherein the enzyme is a raw starch degrading enzyme.

18. A method according to claims 14 to 17 wherein the feed is a feed for swine or poultry.

19. A method according to claim 18 wherein the feed is a raw material such as a legume or a cereal.

20. Use of an enzyme in the preparation of a feed comprising a starch, to degrade resistant starch, wherein the enzyme has amylase activity and is capable of degrading said resistant starch.

21. Use of an enzyme in the preparation of a feed to improve the calorific value of said feed, wherein the enzyme has amylase activity and is capable of degrading resistant starch.

22. Use of an enzyme in the preparation of a feed to improve animal performance, wherein the enzyme has amylase activity and is capable of degrading resistant starch.

23. The use according to any one of claims 20 to 22, wherein the enzyme is thermostable.

24. The use according to any one of claims 20 to 23, wherein the enzyme is pH stable.

25. A process for preparing a feed comprising admixing a starch and an enzyme, wherein the enzyme has amylase activity and is capable of degrading resistant starch.

26. A process for identifying a component for use in a feed, wherein said component comprises an enzyme, said process comprising contacting resistant starch with a candidate component and determining the extent of degradation of said resistant starch; wherein said enzyme has amylase activity and is capable of degrading said resistant starch.

27. A process according to claim 25 or claim 26, wherein the enzyme is thermostable.

28. A process according to any one of claims 25 to 27, wherein the enzyme is pH stable.

29. A component substantially as described herein and with reference to the accompanying Examples.

30. A feed substantially as described herein and with reference to the accompanying Examples.

31. A use substantially as described herein and with reference to the accompanying Examples.

32. A process for preparing a feed substantially as described herein and with reference to the accompanying Examples.

33. A process for identifying a component for use in a feed substantially as described herein and with reference to the accompanying Examples.
